(19) United States
(12) Patent Application Publication
(10) Pub. No.: US 2014/0189092 A1
(43) Pub. Date: Jul. 3, 2014

(54) System and Method for Intelligent Data Center Positioning Mechanism in Cloud Computing

(71) Applicant: FUTUREWEI TECHNOLOGIES, INC., Plano, TX (US)

(72) Inventor: Hong Zhang, Palo Alto, CA (US)

(73) Assignee: FutureWei Technologies, Inc., Plano, TX (US)

(21) Appl. No.: 13/730,545

(22) Filed: Dec. 28, 2012

(51) Int. Cl. H04L 12/24

(52) U.S. Cl. CPC H04L 41/50
USPC 709/224

(57) ABSTRACT

An intelligent data center (DC) positioning mechanism is supported for a cloud computing environment. The intelligent DC positioning mechanism automatically selects an optimal DC from a set of candidate DCs to serve a user. A service request is received from a user at a service portal. The service request is then sent and processed by a DC positioning engine in the cloud computing environment. To select the optimal DC, a plurality of DCs are queried for price-tier and capability information to service the request. A list of candidate DCs is then established in accordance with the price-tier and capability information. A plurality of attributes including internal DC attributes is also obtained. The candidate DCs in the list are then ranked in accordance with the attributes including the internal DC attributes and a highest ranked DC in the list is selected to serve the service request.

### TECHNICAL FIELD

The present invention relates to a system and method for cloud computing, and, in particular embodiments, to a system and method for an intelligent data center positioning mechanism in cloud computing.

### BACKGROUND

Cloud computing is the use of computing resources (hardware and software) that are delivered as a service over a network (typically the Internet). The name comes from the use of a cloud-shaped symbol as an abstraction for the complex infrastructure it contains in system diagrams. Cloud computing entrusts remote services with a user's data, software and computation. The cloud computing or network providers manage the infrastructure and platforms on which the applications run. End users access cloud-based applications through a web browser or a light-weight desktop or mobile application (also referred to as an app), while the software and user's data are stored on servers at a remote location. Cloud computing relies on sharing of resources over a network using converged infrastructure and shared services.

To support cloud computing, physical resources need to be virtualized and managed. There are schemes to virtualize physical data center resources (e.g., CPU, memory, disk space, bandwidth, and/or others) and to manage the virtualized resources. Managing resources also includes positioning (i.e. allocation) of a data center to handle user service requests in the public/private cloud network or system, which consists of many data centers. The positioning of a data center is usually statically configured for a user's service. The resource positioning mechanisms are about virtual machine (VM) positioning or management inside a server, but do not provide automatic data center positioning to best serve a user's service request and optimally use a data center's resources.

Cisco is developing a network positioning system that only exposes the underlying network intelligence to a cloud-based application/user, which then has to make the decision about the positioning. Cisco's Network Positioning System (NPS) provides basically the following real-time information about the network: proximity and performance as well as a ranking list of data centers based on either proximity or performance. The system requires the user to specify which of the provided attributes the ranking should be based on. This method is fairly complex from the user's point of view since the user needs to have good knowledge about what the provided network proximity numbers or network performance numbers mean. The method also reduces the provider's flexibility. With positioning control in the hands of the user, the provider does not have the flexibility to perform positioning and initiate seamless service migration in case of failure. Also Cisco's mechanism does not consider data center's internal performance and data center's resource equivalence and performance equivalence, which are useful to ensure high or satisfactory performance of the user's service and efficient usage of data center resources.

In view of such limited data center positioning mechanisms, there is a need for an improved intelligent data center positioning mechanism that better guarantees the optimal data center in term of performance for serving users/applications and that allows providers more control over the positioning process without placing complexity or burden on the user.

### SUMMARY OF THE INVENTION

In accordance with an embodiment, a method for data center positioning in cloud computing comprises receiving a service request from a user, querying a plurality of data centers (DCs) for price-tier and capability information to service the request, and establishing a list of candidate DCs in accordance with the price-tier and capability information. The method further comprises obtaining a plurality of attributes including internal DC attributes, ranking the candidate DCs in the list in accordance with the attributes including the internal DC attributes, and selecting a highest ranked DC in the list to serve the service request.

In another embodiment, a network component for DC positioning in cloud computing comprises a processor and a computer readable storage medium storing programming for execution by the processor. The programming including instructions to receive a service request from a user, query a plurality of DCs for price-tier and capability information to service the request, and establish a list of candidate DCs in accordance with the price-tier and capability information. The programming includes further instructions to obtain a plurality of attributes including internal DC attributes, rank the candidate DCs in the list in accordance with the attributes including the internal DC attributes and select a highest ranked DC in the list to serve the service request.

In yet another embodiment, an apparatus for DC positioning in cloud computing comprises a service portal configured to receive a service request from a user and a DC positioning engine (DCPE) coupled to the service portal and configured to establish a list of candidate DCs in accordance with price-tier and capability information for the DCs. The DCPE further ranks the candidate DCs in the list in accordance with a plurality of attributes including internal DC attributes, wherein the service request is served by a highest ranked DC in the list.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is an embodiment of a cloud computing system for intelligent DC positioning;

FIG. 2 is an embodiment method for intelligent DC positioning in cloud computing; and

FIG. 3 is a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

A cloud network, also referred to herein as the cloud, can consist of many data centers (DCs) interconnected through one or more networks, for example a wide area network (WAN) or a local area network (LAN). Each data center may comprise many computing servers, storage blocks, firewalls, load balancers, and possibly other components interconnected through switches/routers. In cloud computing, when a user requests a service from the cloud, one task of the cloud is to decide which data center is best to serve this request. An inefficient or less than optimal selection could result in poor performance, limited scalability, congestion on the backbone network which may have limited bandwidth, and/or inefficient use of data center resources. Selecting and assigning a DC to serve the user is referred to herein as DC positioning.

Disclosed herein is a system and method for providing a smart or intelligent DC positioning mechanism (in comparison to current schemes), which can automatically select an optimal DC to serve a user in cloud computing. The mechanism ensures optimal selection of DC resources (for computing, storage, bandwidth, etc.) in a cloud network. The system and method provides the user a service portal to enter a service request and optionally service attributes associated with the request. The portal sends the service request with the service attributes (if provided) to a DC positioning engine in the cloud.

The DC positioning engine locates the optimal DC for the service using an intelligent data center positioning scheme or method. The selection is based on DC/network attributes, e.g., in addition to the attributes provided with the request. The DC/network attributes may be provided by the cloud and the different DCs and include DC capability, DC communication cost, DC performance attributes, DC resource equivalence, other DC/network parameters, or combinations thereof. The various attributes are combined for different available DCs in the cloud. The combined attributes for the different DCs are then used to rank the DCs and select the optimal DC for serving the user's request to ensure performance, scalability, and availability of cloud services to users.

For instance, the selection can be based on at least one of a plurality of attributes, including network communications cost from the user to the DC, the DC's performance, the DCs resource equivalence, and the DC's performance equivalence, as described in detail below. The DC positioning engine can also assign a weight to each of the above attributes (e.g., a weight of zero means that the attribute is not taken into consideration, and calculate a normalized value based on a weighted sum of the attributes. The DC positioning engine then ranks the DCs according to the normalized value and selects the optimal data center for serving the user.

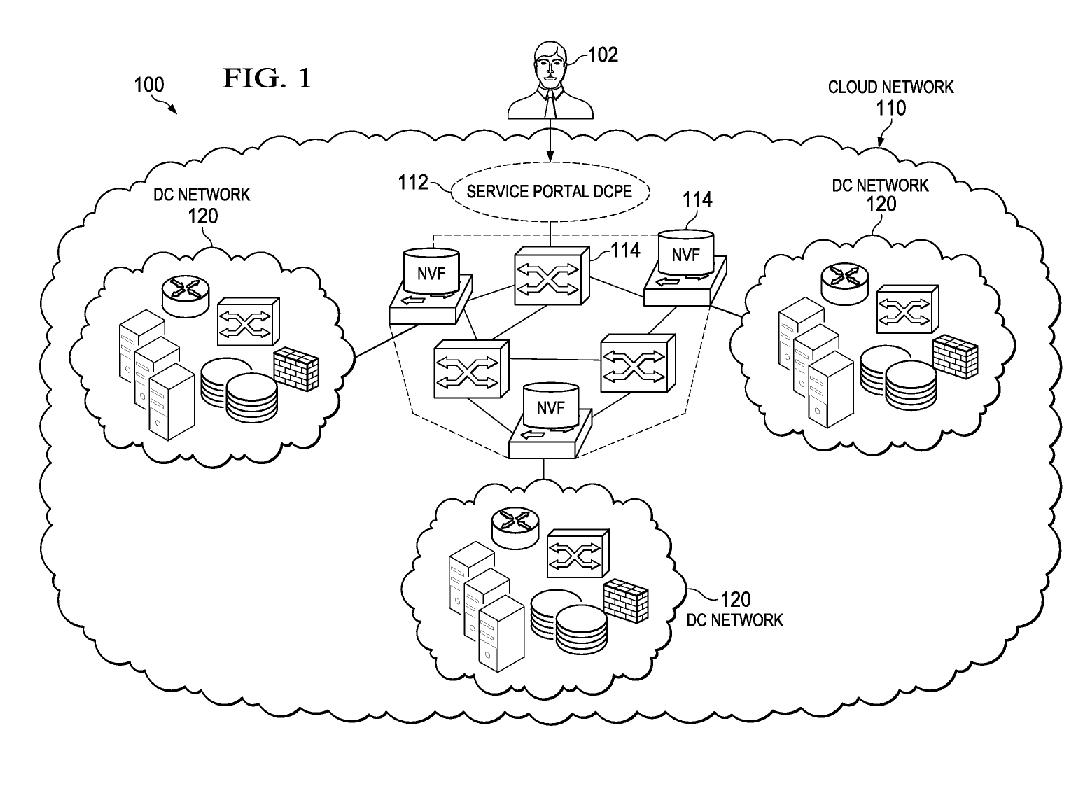

FIG. 1 shows an embodiment of a cloud computing system 100 that provides an intelligent DC positioning mechanism in cloud computing. The cloud computing system 100 includes a cloud network 110 that provides cloud computing services to one or more users 102. The users 102 are associated with or correspond to applications or services (e.g., apps or web applications). The users 102 are also associated with user equipments (UEs) that run the applications or services. The cloud network 110 is any network (e.g., a LAN, a WAN, the Internet, or any combination of multiple networks) that comprises and/or is coupled to a plurality of DCs 120 via a plurality of routers 114 or similar purpose network components.

The cloud system 100 also comprise a DC positioning system 112 positioned between the users 102 and the DCs 120. The DC positioning system 112 may be coupled to or located at the cloud network 110. The DC positioning system 112 includes a service portal and a DC positioning engine (DCPE). The two components may be implemented via software, hardware, or both. The service portal and the DCPE may be one integrated function or may be separate functions co-located in the same component or location, for example at a dedicated gateway or server or alternatively at any one of the routers 114 that communicate with the user 102. In another embodiment, the service portal and the DCPE may be located at different components or locations.

The service portal is configured to receive or intercept service requests from a user 102 for cloud computing applications/services. The service portal forwards the request to the DCPE. The DCPE is configured to allocate or select an optimal DC to service the user request, also referred to herein as DC positioning. Specifically, the DCPE implements an intelligent DC positioning scheme or method that selects a DC with best or optimal resources and attributes to serve the user 102. The optimal DC is selected based on a plurality of DC and network attributes and optionally attributes or criteria provided by the user 102 with the service request and/or by the service provider.

The intelligent DC positioning scheme starts by first querying a resource manager entity for each DC 120 about the DC's price-tier and capability to satisfy the service request. Based on the price-tier and capability responses from the queried DCs 120, the DCPE may establish a candidate list of DCs that can satisfy the service requirement. The DCPE then ranks the candidate DCs to select the best or optimal (i.e., highest ranking) DC based on a plurality of DC/network related attributes and optionally service attributes, e.g., indicated with the request. For instance, the service attributes may include (but are not limited to) price-tier, number of virtual machines (VMs_, types of VMs (e.g., Vsphere hypervisor or Microsoft Hiper-V or Linux Xen), security requirement, storage blocks, performance parameters, other attributes, or combinations thereof. The service attributes can be designated by the user 102 and/or the service provider.

The optional service attributes (e.g., price-tire, number of VMs, etc.) can be used to find a candidate list of DCs that can satisfy the service requirement. For example, the optional attributes are the service requirements which map to each DC's capability. The DCs with capability that can satisfy these service attributes may then be selected as candidates. When there are more than one DC candidates, the DCPE ranks the candidate DCs to select the optimal DC for serving the user 102.

The DC/network attributes include networking communication cost from the user to the DC, DC performance, DC resource equivalence, data center's performance equivalence, other DC resource or performance related attributes, or combinations thereof. The DCPE may assign a weight to each of the above attributes, for instance based on user/application requirement or service provider criteria (e.g., Quality of service (QoS)). As such, the DCPE selects the optimal or best DC based on a normalized value or combination of the attributes.

The network communication cost is a function of the network proximity and network performance between the user and the DC. Network proximity refers to the logical distance from the user to the DC. The logical distance can be computed based on the routing cost obtained from the routing and/or forwarding layer (e.g., OSPF, ISIS, BGP, or other) and may take into consideration policy, geo-location, and other routing and/or forwarding criteria such as MPLS-TE (RSVP). Lower cost is associated with closer network proximity. Network performance refers to the latency, jitter, packet loss, and/or bandwidth availability between the user and the DC. Lower cost is also associated with better network performance.

The DC performance can be measured by a plurality of metrics inside the DC, such as networking status and performance, compute status and performance, storage status and performance, other metrics, or combinations thereof. The DC resource equivalence can be measured by load variation among the loads of the different types of resources of a DC. Better equivalence is associated with smaller variation. The resource equivalence may be evaluated taking into consideration the load of the service request. DC resource equivalence is measured to avoid depleting one type of resource while leaving other types of resources underused. Maintaining resource equivalence avoids having to serve a user request by resources from different DCs located at different geographic locations, which may degrade performance and inject unnecessary network traffic into the cloud network 110. Maintaining resource equivalence also leads to efficient use of resources.

The DC performance equivalence can be measured by the performance variation among the different types of resources of the DC. DC performance equivalence is measured to avoid having some service associated tasks in wait for other slower tasks (e.g., in a queue of scheduled tasks). Selecting resources with equivalent performance may enhance service performance and optimize resource usage.

Compared with other positioning schemes (e.g., static configuration for user services or Cisco's NPS scheme), the intelligent DC positioning scheme above allows service providers the flexibility to perform automatic DC positioning (or selection) and initiate seamless service migration in case of failure, for example. The scheme can also be used for service scale up/down and new service placement. The scheme herein also ranks DCs based on a normalized value of comprehensive cloud resource attributes rather than an absolute value of a single attribute. As described above, the attributes include internal DC attributes and service attributes in addition to network attributes (e.g., proximity and performance). The DC selection takes into account the DC's internal performance and resource equivalence in the ranking process, which may ensure performance of services and lead to efficient usage of DC resources and cost reduction. Additional advantages of the intelligent and automatic (i.e., system driven) DC positioning scheme include improved service response time and service execution and mitigation of network congestion. The scheme also ensures meeting service-level agreement (SLA) for the service request, e.g., including price-tier, performance, and security.

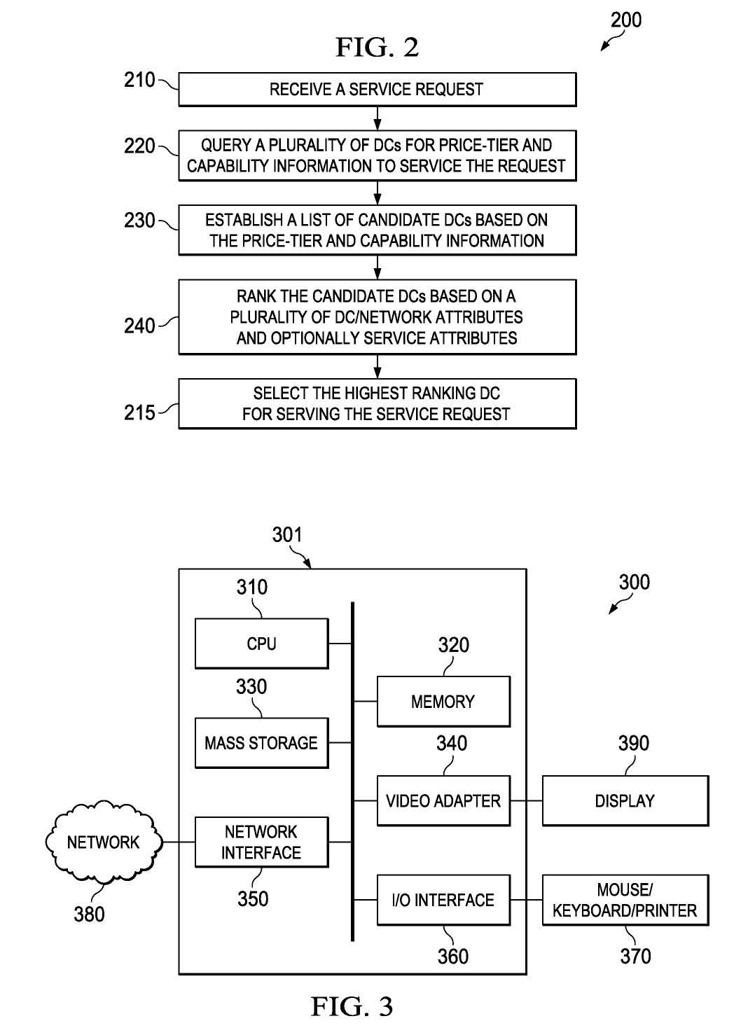

FIG. 2 shows an embodiment method 200 for intelligent DC positioning in cloud computing. The method 200 corresponds to or is part of the intelligent DC positioning scheme above. For instance, the method 200 is implemented by the DC positioning system 112, e.g., at a network component. At step 210, a service request is received from a user, e.g., by the service portal. The service portal then forwards the request to the DCPE. At step 220, a plurality of DCs are queried, e.g., by the DCPE, for price-tier and capability information to service the request. At step 230, a list of candidate DCs is established based on the price-tier and capability information. At step 235, a plurality of DC/network attributes and optionally service attributes are obtained. At step 240, the candidate DCs are ranked based on the DC/network attributes and the service attributes (if available). The different attributes may be weighted and combined, for example as a weighted sum, to obtain a normalized value for each DC. At step 250, the highest ranking DC is selected for serving the service request.

FIG. 3 is a block diagram of a processing system 300 that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 300 may comprise a processing unit 301 equipped with one or more input/output devices, such as a speaker, microphone, mouse, touchscreen, keypad, keyboard, printer, display, and the like. The processing unit 301 may include a central processing unit (CPU) 310, a memory 320, a mass storage device 330, a video adapter 340, and an I/O interface 360 connected to a bus. The bus may be one or more of any type of several bus architectures including a memory bus or memory controller, a peripheral bus, a video bus, or the like.

The CPU 310 may comprise any type of electronic data processor. The memory 320 may comprise any type of system memory such as static random access memory (SRAM), dynamic random access memory (DRAM), synchronous DRAM (SDRAM), read-only memory (ROM), a combination thereof, or the like. In an embodiment, the memory 320 may include ROM for use at boot-up, and DRAM for program and data storage for use while executing programs. In embodiments, the memory 320 is non-transitory. The mass storage device 330 may comprise any type of storage device configured to store data, programs, and other information and to make the data, programs, and other information accessible via the bus. The mass storage device 330 may comprise, for example, one or more of a solid state drive, hard disk drive, a magnetic disk drive, an optical disk drive, or the like.

The video adapter 340 and the I/O interface 360 provide interfaces to couple external input and output devices to the processing unit. As illustrated, examples of input and output devices include a display 390 coupled to the video adapter 340 and any combination of mouse/keyboard/printer 370 coupled to the I/O interface 360. Other devices may be coupled to the processing unit 301, and additional or fewer interface cards may be utilized. For example, a serial interface card (not shown) may be used to provide a serial interface for a printer.

The processing unit 301 also includes one or more network interfaces 350, which may comprise wired links, such as an Ethernet cable or the like, and/or wireless links to access nodes or one or more networks 380. The network interface 350 allows the processing unit 301 to communicate with remote units via the networks 380. For example, the network interface 350 may provide wireless communication via one or more transmitters/transmit antennas and one or more receivers/receive antennas. In an embodiment, the processing unit 301 is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for data center positioning in cloud computing, the method comprising:
receiving a service request from a user;
querying a plurality of data centers (DCs) for price-tier and capability information to service the request;
establishing a list of candidate DCs in accordance with the price-tier and capability information;
obtaining a plurality of attributes including internal DC attributes;
ranking the candidate DCs in the list in accordance with the attributes including the internal DC attributes; and
selecting a highest ranked DC in the list to serve the service request.

2. The method of claim 1, further comprising:
assigning a weight to each of the attributes; and
combining the weighted attributes to obtain a normalized value of the attributes for each of the DCs, wherein the DCs are ranked in accordance with the normalized value.

3. The method of claim 1, further comprising receiving service attributes from the user, a service provider, or both.

4. The method of claim 1, wherein obtaining the attributes includes obtaining networking communication cost between the user and DC, DC performance, DC resource equivalence, DC performance equivalence, or combinations thereof.

5. The method of claim 4, wherein obtaining networking communication cost between the user and DC comprises:
calculating network proximity between the user and DC using a routing layer, a forwarding layer, or both; and
associating lower cost with closer network proximity.

6. The method of claim 5, wherein network proximity is calculated as a logical distance between the user and DC taking into consideration at least one of policy, geo-location, and other routing criteria, forwarding criteria, or both.

7. The method of claim 4, wherein obtaining networking communication cost between the user and DC comprises:
evaluating network performance of a DC; and
associating lower cost with better network performance.

8. The method of claim 7, wherein network performance is evaluated in terms of at least one of latency, jitter, packet loss, and bandwidth availability between the user and the DC.

9. The method of claim 4, wherein obtaining DC performance comprises measuring a plurality of metrics internal to a DC including at least one of networking status and performance, compute status and performance, and storage status and performance.

10. The method of claim 4, wherein obtaining DC resource equivalence comprises:
measuring load variation among loads of different types of resources for a DC; and
associating better equivalence with smaller load variation.

11. The method of claim 4, wherein obtaining DC performance equivalence comprises measuring performance variation among different types of resources of a DC.

12. A network component for data center positioning in cloud computing, the network component comprising:
a processor; and
a computer readable storage medium storing programming for execution by the processor, the programming including instructions to:
receive a service request from a user;
query a plurality of data centers (DCs) for price-tier and capability information to service the request;
establish a list of candidate DCs in accordance with the price-tier and capability information;
obtain a plurality of attributes including internal DC attributes;
rank the candidate DCs in the list in accordance with the attributes including the internal DC attributes; and
select a highest ranked DC in the list to serve the service request.

13. The network component of claim 12, wherein the programming includes further instructions to:
assign a weight to each of the attributes; and
combine the weighted attributes to obtain a normalized value of the attributes for each of the DCs, wherein the DCs are ranked in accordance with the normalized value.

14. The network component of claim 12, wherein the programming includes further instructions to receive service attributes from the user, a service provider, or both.

15. The network component of claim 14, wherein the service attributes include price-tier information, number of virtual machines, security requirement, storage blocks, performance parameters, or combinations thereof.

16. The network component of claim 14, wherein the attributes include DC capability, DC communication cost, DC performance attributes, DC resource equivalence, or combinations thereof.

17. An apparatus for data center positioning in cloud computing, the apparatus comprising:
a service portal configured to receive a service request from a user; and
a data center positioning engine (DCPE) coupled to the service portal and configured to establish a list of candidate data centers (DCs) in accordance with price-tier and capability information for the DCs and rank the candidate DCs in the list in accordance with a plurality of attributes including internal DC attributes,
wherein the service request is served by a highest ranked DC in the list.

18. The apparatus of claim 17, wherein the attributes further include cloud network related attributes, including proximity and performance attributes, and optionally service attributes from the user, a service provider, or both.

19. The apparatus of claim 17, wherein the service portal and the DCPE are integrated into a single network component or co-located at a single network location.

20. The apparatus of claim 17, wherein the service portal and the DCPE are located at different network components or locations.
